(19) United States
(12) Patent Application Publication
(10) Pub. No.: US 2013/0118128 A1
(43) Pub. Date: May 16, 2013

(54) COMPOSITE FILM AND PACKAGING PRODUCED THEREFROM

(71) Applicants: Andreas LUECKE, Duelmen (DE); Andre Ebbers, Bochum (DE); Christian Lettmann, Coesfeld (DE)

(72) Inventors: Andreas LUECKE, Duelmen (DE); Andre Ebbers, Bochum (DE); Christian Lettmann, Coesfeld (DE)

(21) Appl. No.: 13/676,844

(22) Filed: Nov. 14, 2012

(30) Foreign Application Priority Data
Nov. 15, 2011 (DE) 102011086366.4

(51) Int. Cl. B65D 65/40; B65B 51/22; B32B 15/08; B65B 3/16

(52) U.S. Cl. CPC B65D 65/40; B65B 3/16; B65B 51/225; B32B 15/08
USPC 53/469; 53/396; 53/479; 428/447; 428/412; 428/419; 428/425.5

(57) ABSTRACT

The present invention relates to multilayer packaging films with at least one layer containing a thermoplastic, where a coating containing at least one silicone has been applied on that side of the packaging film that faces towards the product requiring packaging, and to use of these, and to packaging processes using the packaging films mentioned.

### CROSS-REFERENCE TO RELATED APPLICATIONS

This application is based upon and claims the benefit of priority from prior German Patent Application DE 10 2011 086 366.4 filed on Nov. 15, 2011, the entire contents of which are incorporated by reference herein.

### BACKGROUND OF THE INVENTION

The present invention relates to multilayer packaging films with at least one layer comprising thermoplastic, where a coating comprising at least one silicone has been applied on that side, of the packaging film that faces towards the product requiring packaging and to use of these, and to packaging processes using the packaging films mentioned.

The packaging of products requiring packaging is of increasing importance, both for transport purposes and for storage of the products requiring packaging. In this context, packaging is used in every sector of industry and of everyday life. By way of example, the products requiring packaging can be food or drink for sale to consumers, or else commodity chemicals or speciality chemicals. The packaging here should be easy to open, but in particular also permit residue-free removal of the product requiring packaging, and the intention is therefore that, even after a prolonged storage time, the product requiring packaging does not adhere to the packaging or bond thereto. At the same time, however, the intention is that the packaging protects the product requiring packaging from external influences, for example from exposure to electromagnetic radiation, in particular UV radiation, or from exposure to air and moisture, where these can lead to ageing of the product requiring packaging. Familiar packaging is based on films, and multilayer films are often involved here. Multilayer films of this type are also termed composite films and are disclosed by way of example in DE 2164461, DE 1932886, DE 2445227, DE 20201655 or DE 202055009073.

Despite the known packaging materials, there is a constant need for optimization and improvement, in particular in respect of the properties of the packaging materials. It is an object of the present invention to provide packaging for goods requiring packaging, in particular for reactive products.

### BRIEF SUMMARY OF THE INVENTION

Accordingly, the present invention first provides a multilayer packaging film with at least one layer comprising thermoplastic, where a coating comprising at least one silicone has been applied on that side of the packaging film that faces towards the product requiring packaging.

Surprisingly, a consequence of the application of the at least one silicone on that side of the packaging film that faces towards the product requiring packaging has been found to be the possibility of in particular residue-free removal of the film from the product requiring packaging.

In principle, a packaging film has two sides, an upper and a lower side when viewed laterally. As a function of the design of the packaging, one of the two sides comes into contact with the product requiring packaging, and this means that one of the two sides faces towards the product requiring packaging. For the purposes of the present invention it is essential that that side of the packaging film that faces towards the product requiring packaging has a coating comprising at least one silicone.

In the simplest embodiment, the packaging film according to the invention is composed of a layer comprising thermoplastic, and at least on one side of the film there is at least one silicone applied on the said layer. It is preferable that the packaging film according to the invention involves a multilayer film, and this means that a composite made of a plurality of sublayers or layers made of different materials (hereinafter also termed composite film) has been coated on one side with at least one silicone. Composite films according to the present invention generally involve multiple-sublayer or multilayer films in which at least one layer comprises thermoplastic.

According to the invention, the packaging films have at least two layers: a layer comprising thermoplastic and a layer of at least one silicone. It is preferable that the packaging films according to the invention have at least three layers, in particular four or more layers.

In one preferred embodiment of the present invention, the packaging film has two layers of at least one polymer and, located between the layers, a metal sublayer, where at least one of the two layers of at least one polymer comprises at least one thermoplastic. The material therefore involves a three-layer main system made of two polymer films, of which at least one layer comprises thermoplastic, and of a metal sublayer located between the two polymer layers mentioned. This three-layer composite film has then, according to the invention, been coated with at least one silicone on the side facing towards the product requiring packaging. According to the invention, this gives, in totality, a packaging film with four layers. An advantage of composite films of this type and of packaging produced therefrom is that
they are impermeable to water diffusion,
they withstand even high draw-off temperatures of more than 150° C., thermally and mechanically,
products requiring packaging, such as hot-melt adhesives, in particular even reactive hot-melt adhesives, do not adhere thereto,
residue-free release of the products requiring packaging, in particular hot-melt adhesives, is possible and
the products requiring packaging can be charged in a (continuous) automated process.

### BRIEF DESCRIPTION OF THE SEVERAL VIEWS OF THE DRAWINGS

FIG. 1 depicts examples of sonotrode geometries and/or anvil geometries.

FIG. 2 depicts geometry combinations.

FIG. 3 depicts the definition of Angle 1 and Angle 2.

### DETAILED DESCRIPTION OF THE INVENTION

Additional objects, advantages and other features of the present invention will be set forth in part in the description that follows and in part will become apparent to those having ordinary skill in the art upon examination of the following or may be learned from the practice of the present invention. The advantages of the present invention may be realized and obtained as particularly pointed out in the appended claims. As will be realized, the present invention is capable of other and different embodiments, and its several details are capable of modifications in various obvious respects, all without departing from the present invention. In this regard, the description herein is to be understood as illustrative in nature, and not as restrictive.

As used herein the term (meth)acrylic means methacrylic and acrylic, and supports both terms.

For the purposes of the present invention, thermoplastics are polymers which can be (thermoplastically) deformed within a certain temperature range. An advantage of thermoplastics is that they can be welded.

The thermoplastic is preferably one selected from the group consisting of polyolefins, such as polyethylene (PE) and polypropylene (PP), polyamides (PA), polybutadiene, polyesters, polycarbonates (PC), polyvinyl acetate, thermoplastic polyacrylamides, polyacrylonitrile (PAN), polymethylpentene, polyphenylene sulphide, polyurethanes, styrene-acrylonitrile, acrylonitrile-butadiene-styrene (ABS), styrene-butadiene rubber, polyethylene terephthalate (PET). It is preferable to use polyolefins, in particular polyethylene and polypropylene, polyamides and polyethylene terephthalate as thermoplastic.

The thickness of the layers of the polymers mentioned is generally from 2 μm to 1 mm, in particular from 4 μm to 500 μm, preferably from 6 μm to 200 μm and very particularly preferably from 8 μm to 100 μm.

In the abovementioned preferred embodiments with more than two layers, the thermoplastics mentioned above can be combined with one another in any desired manner. In the particularly preferred embodiment with two layers of at least one polymer and, located between the layers, a metal sublayer, there can be, on the respective side of the metal sublayer, identical or different polymer layers, in particular made of polyolefins, preferably polyethylene or polypropylene, or of polyamides or polyethylene terephthalate.

The metal sublayer (also termed metal foil) is in particular composed of lightweight metal, preferably aluminium, and this means that there is preferably an aluminium foil between the polymer layers. The thickness of the metal foil layer is generally from 2 μm to 800 μm, in particular from 4 μm to 200 μm, preferably from 5 μm to 100 μm and very particularly preferably from 6 μm to 50 μm.

In another embodiment, the metal sublayer is composed of aluminium which has been applied from the vapour phase or by (cathode) atomisation.

It is very particularly preferable that the packaging film according to the invention has the following structure:

1^{st} layer: silicone
2^{nd} layer: polyethylene, polypropylene, polyethylene terephthalate, polyacrylonitrile or polyamide
3^{rd} layer: metal sublayer, in particular aluminium
4^{th} layer: polyethylene, polypropylene, polyethylene terephthalate, polyacrylonitrile or polyamide
where the 1^{st} layer faces towards the product requiring packaging.

It is very particularly preferable that the 2^{nd} and the 4^{th} layer are of the same material.

As a function of application, preference can be given to a specific structure of the packaging film.

If the application requires very low water vapour permeability, the preferred embodiment is characterized in that the polymer of at least one of the two layers 2^{nd} and 4^{th} is one selected from polyethylene, polypropylene, (amorphous) polyethylene terephthalate. It is particularly preferable that the thickness of at least one of the layers 2^{nd} and 4^{th} is from 8 to 200 μm.

In this case, the metal layer can have a preferred thickness of from 6 to 100 μm.

If the application requires high thermal stability, the preferred embodiment is characterized in that the polymer of at least one of the two layers 2^{nd} and 4^{th} is one selected from polyethylene terephthalate, polyacrylonitrile and polyamide. It is particularly preferable that the thickness of at least one of the layers 2^{nd} and 4^{th} is from 8 to 200 μm.

In the preferred multilayer packaging films according to the invention there can be, between the individual layers, an adhesion promoter which promotes the adhesion of the individual layers to one another. It is also preferable that in the preferred embodiment made of a metal sublayer coated on both sides with polymers the individual layers have also been bonded to one another by way of adhesion promoter. Particularly suitable adhesion promoters between the layers of the multiple-sublayer packaging film are the conventional primers known for the film lamination process, these being selected in accordance with the mode of operation and with the properties required from the composite. Examples of appropriate adhesion promoters are polymers and copolymers based on urethane, ethylene polymers comprising polar groups, and polymers and copolymers based on vinyl acetate, and also polymers and copolymers based on acrylic acids.

It is essential to the subject matter of the present invention that, on the side facing towards the product requiring packaging, there is a coating comprising at least one silicone. For the purposes of the present invention, silicones (also poly(organo)siloxanes below) are polymers in which silicon atoms have been linked to one another by way of oxygen atoms. It is preferable that the silicones involved are radiation-curable polysiloxanes. Polysiloxanes of this type are known to the person skilled in the art for example from DE 3820294, EP 0940458, EP 0940422 or EP 1544232. In particular, the silicone involves polysiloxanes comprising (meth)acrylate groups. Radiation-curable polysiloxanes are those polysiloxanes that can crosslink on irradiation with ultraviolet electromagnetic radiation or with electron bars.

Materials used with very particular preference as silicone are polysiloxanes of the general average formula (I) having central and terminal, or only central, (meth)acrylate-bearing groups bonded by way of SiOC groups

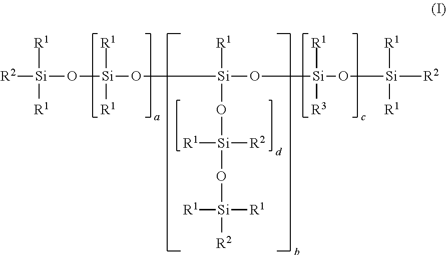

in which
R1 are identical or different moieties selected from linear and branched, saturated, mono- or polyunsaturated alkyl, aryl, alkaryl or aralkyl moieties having from 1 to 20 carbon atoms,
R2 are identical or different moieties R1 or R3,
R3 are identical or different mono- or poly(meth)acrylated monoalkoxylates or (meth)acrylated polyalkoxylates, or a mixture of mono- or poly(meth)acrylated monoalkoxylates or polyalkoxylates with any desired other alkoxylates selected from the group of the linear or branched, saturated, mono- or polyunsaturated, aromatic, aliphatic-aromatic mono- or polyalcohols, polyether monoalcohols, polyether polyalcohols, polyester monoalcohols, polyester polyalcohols, aminoalcohols, in particular N-alkyl, arylamino-ethylene oxide, -propylene oxide alcohols, N-alkyl or arylamino alkoxylates, and also mixtures of these, where the ratio of the mono- or poly(meth)acrylated monoalkoxylates or polyalkoxylates to the any desired other alkoxylates is selected in such a way that at least one mono- or poly(meth)acrylated monoalkoxylate moiety or corresponding polyalkoxylate moiety is present in the organopolysiloxane,
a is from 0 to 1000, preferably from 0 to 500, in particular from 0 to 300,
b is from 0 to 5,
c is from 1 to 200, preferably from 2 to 100, in particular from 3 to 80,
d is from 0 to 1000, preferably from 0 to 500, in particular from 0 to 300.

Polysiloxanes of this type and processes for their production are described in EP 1544232, the content of which is explicitly incorporated concomitantly within the scope of the present invention.

It is preferable to use, as polysiloxanes, compounds of the formula (II)

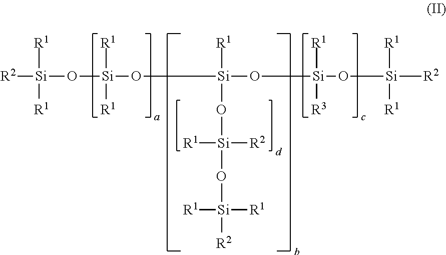

in which
R1 and R2 are linear or branched, saturated, alkyl moieties having from 1 to 20 carbon atoms, in particular methyl, ethyl or propyl, very particularly preferably methyl,
R3 are identical or different mono- or poly(meth)acrylated monoalkoxylates or (meth)acrylated polyalkoxylates
a is from 0 to 100,
b is from 0 to 5
c is from 3 to 20
d is from 0 to 300.

Examples of suitable siloxanes are the commercially available products from the TEGO® RC product range from Evonik Industries AG, in particular TEGO® RC 902, TEGO® RC 711, TEGO® RC 715 or TEGO® RC 351.

Mixtures of various polysiloxanes which are mixed with one another only after separate production are likewise possible.

Individual, or mixtures of appropriate, polysiloxanes can be mixed in any desired mixture with any desired number of other (meth)acrylated polysiloxanes according to the prior art. Mixtures with epoxy-containing or vinyl-ether-containing UV-curing silicones are also possible.

The polysiloxanes mentioned or the mixtures mentioned can moreover be mixed with other auxiliaries and additives according to the prior art. Particular mention may be made here of photoinitiators, in particular 2-hydroxy-2-methylphenyl-1-propanone, adhesion promoters, curing accelerators, photosensitizers, antioxidants, oxygen scavengers and organic compounds comprising (meth)acrylic groups or comprising vinyl ether groups. Other additives are dyes, pigments, and also solid particulate fillers.

The thickness of the coating with the abovementioned silicones is generally from 0.1 g/m² to 4 g/m², preferably from 0.2 to 2 g/m² and very particularly preferably from 0.3 to 1 g/m².

The silicones mentioned, in particular polysiloxanes, can be applied by any of the methods known to the person skilled in the art, in particular by roller coating, coating with a doctor, offset printing, gravure printing, spray coating. Pretreatment of the substrate can precede the coating, an example being corona-discharge treatment or plasma treatment.

The packaging films according to the invention, in particular the preferred embodiments, feature high stability and impermeability. Accordingly, the present invention also provides the use of the packaging films according to the invention for the packaging of products requiring packaging. Suitable products requiring packaging are generally any of the products involved in everyday life or required by industry. Examples of products required by industry are chemicals, in particular those which are intended to be drawn off into appropriate film packaging. One particularly preferred type of product requiring packaging is provided by hot-melt adhesives of any chemical composition.

Hot-melt adhesives are solvent-free adhesives which in hot conditions and in the liquid state can wet surfaces of materials effectively and which, after cooling and solidification, adhere securely on the same. They are generally composed of a mixture of substances which form the adhesive component, the cohesive component and the additive component. During production, the components are melted together and then compounded. The materials known as pressure-sensitive hot-melt adhesives cause particular difficulties during the compounding process, these being hot-melt adhesives with long-lasting tack, which therefore retain their tack even at room temperature.

The packaging film according to the invention is suitable for the packaging of practically any type of hot-melt adhesive composition. It is particularly advantageous for hot-melt adhesives with serious handling problems, e.g. for the pressure-sensitive hot-melt adhesives which have already been mentioned above and which retain their tack even at room temperature.

By way of example, the packaging film according to the invention can be used for the packaging of hot-melt adhesives which have been produced from polymers and copolymers of synthetic resins, rubbers, polyethylene, polypropylene, polyurethane, acrylic, vinyl acetate, ethylene-vinyl acetate and polyvinyl alcohol.

Specific examples comprise non-reactive or reactive hot-melt adhesives produced from the following components:

1) elastic polymers, such as block copolymers, e.g. styrene-butadiene, styrene-butadiene-styrene, styrene-isoprene-styrene, styrene-ethylene-butylene-styrene, styrene-ethylene-propylene-styrene;
2) ethylene-vinyl acetate polymers, ethylene-ester materials and copolymers, e.g. ethylene methacrylate, ethylene-n-butyl acrylate and ethylene-acrylic acid;
3) polyolefins, such as polyethylene and polypropylene, and also co- or terpolymers, in particular made of ethylene, propylene and butene
4) polyvinyl acetate and copolymers therewith;
5) polyacrylates;
6) polyamides;
7) polyesters;
8) polyvinyl alcohols and copolymers therewith;
9) polyurethanes;
10) polystyrenes;
11) polyepoxides;
12) copolymers of vinyl monomers and of polyalkylene oxide polymers;
13) aldehydes which comprise resins, for example phenol-aldehyde, urea-aldehyde, melamine-aldehyde and the like;
14) silane-modified polymers, in particular silane-modified polyolefins or polyethers.

Other materials that can be present are components for reinforcing adhesion, diluents, stabilizers, antioxidants, dyes and fillers.

Examples that may be mentioned of components for improving adhesion are:

1) natural and modified resins,
2) polyterpene resins,
3) phenol-modified hydrocarbon resins,
4) aliphatic and aromatic hydrocarbon resins,
5) phthalate esters and
6) hydrogenated hydrocarbons, hydrogenated resins and hydrogenated resin esters.

Examples of diluents that may be mentioned are liquid polybutene or polypropylene, petroleum waxes, such as paraffin and microcrystalline waxes, semi-liquid polyethylene, hydrogenated animal, fish and vegetable fats, mineral oil and synthetic waxes, and also hydrocarbon oils.

Examples of the other additives are found in the literature.

The product requiring packaging is in particular one selected from reactive products, and it is preferable that reactive hot-melt adhesives are involved. For the purposes of the present invention, reactive hot-melt adhesives are hot-melt adhesives which after application can also react with the substrate surfaces, for example by virtue of exposure to atmospheric moisture. Adhesives of this type are suitable for particularly high-specification adhesive bonds. They feature very good adhesion properties and excellent strengths. They are applied in the melt and, after cooling, react with atmospheric moisture to give high-molecular-weight compounds that are then very difficult to melt. The high final strength is achieved through the chemical reaction of free reactive groups with surface moisture, and also with appropriate chemical groups on the substrate surfaces. They also feature high chemicals resistance, e.g. to printing-ink oil, and also high resistance to temperature change and to ageing. The reactive, in particular moisture-crosslinking hot-melt adhesives are melted at the user's premises and are generally sprayed through very fine nozzles onto the substrate that is to be adhesive-bonded. It is essential here to avoid any blocking of the nozzles by adhesive particles already hardened by moisture, since this would lead to stoppage of the system. These adhesives must therefore be provided by the producer in packaging that is almost completely impermeable to moisture and which can give long shelf life without ingress of external moisture, e.g. atmospheric moisture.

The packaging films according to the present invention are particularly suitable for the packaging of the moisture-crosslinking hot-melt adhesives mentioned. Packaging films of the particularly preferred embodiment with two layers of at least one polymer and, located between the layers, a metal sublayer, where these have been coated with at least one silicone on the side that faces towards the moisture-crosslinking hot-melt adhesive, are particularly advantageously suitable for the intended purpose mentioned according to the invention. The preferred packaging films are impermeable to water diffusion, and are thermally and mechanically stable even at high draw-off temperatures of more than 150° C.; the hot-melt adhesives do not adhere thereto, and residue-free separation of these from the packaging film is possible. Furthermore, the packaging films mentioned are also suitable for charging in a (continuous) automated process.

The packaging films according to the invention are in particular used for the packaging of hot-melt adhesives based on amorphous poly-alpha-olefins.

The poly-alpha-olefins in particular involve a homo-, co- or terpolymer made of at most 25% by weight, preferably from 1 to 22% by weight, particularly preferably from 2 to 20% by weight and with particular preference from 3 to 18% by weight, of ethene, at most 95% by weight, preferably from 1 to 85% by weight, particularly preferably from 5 to 78% by weight and with particular preference 10 to 75% by weight, of propene and/or from 5 to 100% by weight, preferably from 7 to 98% by weight, particularly preferably from 10 to 95% by weight and with particular preference from 12 to 90% by weight, of an olefin having from 4 to 10 carbon atoms. With particular preference, the polyolefins according to the invention are those selected from poly(1-butene), poly(propylene), poly(propylene-co-ethylene), poly(propylene-co-1-butene), poly(ethylene-co-1-butene) and poly(ethylene-co-propylene-co-1-butene). It is further preferable that the polyolefins are semicrystalline, and in particular therefore semicrystalline poly-alpha-olefins are involved.

A feature of semicrystalline polyolefins is that, during the first and/or second heating procedure in differential calorimetry (DSC), they preferably exhibit at least one melting peak and also a characteristic enthalpy of fusion which is not higher than 50%, preferably not higher than 40%, particularly preferably not higher than 30% and with particular preference not higher than 25%, of the theoretically calculated value for pure isotactic polypropylene (J. Bicerano; J. M. S.; Rev. Macromol. Chem. Phys.; C38 (1998); 391ff).

In one particular embodiment, the olefin having from 4 to 10 carbon atoms can be one selected from the group consisting of 1-butene, 1-pentene, 1-hexene, 1-octene, 1-decene, 3-methyl-1-butene, 3-methyl-1-hexene, 3-methyl-1-heptene, 4-methyl-1-pentene and/or 6-methyl-1-heptene. It is preferable that the alpha-olefin having from 4 to 10 carbon atoms is one selected from the group consisting of 1-butene, 1-hexene and/or 1-octene.

The co- or terpolymers are produced through polymerization of the monomers mentioned, in the amounts mentioned.

The poly-alpha-olefins are obtainable by way of example through polymerization of propylene with ethylene and/or 1-butene and/or with other alpha-olefins having from 4 to 10 carbon atoms, with a TiCl₃.(AlCl₃)ₙ mixed catalyst (n=0.2 to 0.5), where a trialkylaluminium compound is used as cocatalyst. The monomer ethene is used in gaseous form, while the monomers propene and 1-butene can be used in either gaseous or else liquid form. By way of example, gaseous hydrogen can be used to regulate molar mass. The polymerization process is preferably carried out in an inert solvent, for example one selected from the group of the aliphatic hydrocarbons. It is also possible to carry out a polymerization process in the initial charge of monomer. The reaction temperature is from 30 to 200° C. The polymers can be stabilized chemically in accordance with the prior art either in the form of their reaction solution or at a subsequent juncture, in order to protect them from the damaging effect of, for example, insolation, atmospheric moisture and oxygen. By way of example here, it is possible to use stabilizers which comprise hindered amines (HALS stabilizers), hindered phenols, phosphites and/or aromatic amines, in particular esters of pentaerythritol, e.g. tetrakis(methylene-3,5-di-tert-butyl-4-hydroxyhydrocinnamate)methane and/or 2,4,8,10-tetraoxa-3,9-diphosphaspiro-3,9-bisoctadecyloxy[5,5]undecane. It is particularly preferable to use only those stabilizers which comprise only one hydrolytically active terminal group. The effective amount of stabilizers here is in the range from 0.1 to 2% by weight, based on the polymer.

The co- or terpolymers mentioned have preferably been modified in order to obtain reactive, in particular moisture-crosslinking, hot-melt adhesives. In the modification process, one or more monomers having functional groups have been grafted onto the abovementioned co- or terpolymers. The monomers to be grafted onto the materials here preferably have olefinic double bonds. In particular, the one or more monomers having functional groups are those selected from the group of the carboxylic acids and/or carboxylic acid derivatives (for example maleic anhydride, maleic acid, itaconic acid, itaconic anhydride, citric anhydride, acrylic acid, methacrylic acid), of the acrylates (for example hydroxymethyl acrylate, hydroxyethyl acrylate, hydroxypropyl acrylate, methyl methacrylate, ethyl methacrylate, butyl methacrylate, glycidyl methacrylate, etc.), of the vinylsilanes (for example vinyltrimethoxysilane, vinyltriethoxysilane, vinyltris(2-methoxyethoxy)silane, 3-methacryloxypropyltrimethoxysilane, 3-methacryloxypropyltriethoxysilane, vinyldimethylethoxysilane and/or vinylmethyldibutoxysilane, in particular vinyltrimethoxysilane), of the vinylaromatics (for example styrene, α-methylstyrene, divinylbenzene, aminostyrene, styrenesulphonic acid, etc.), of the cyclic imido esters or vinyl compounds of these (e.g. isopentenyl-2-oxazoline, ricinoloxazoline maleate, etc.), of the vinylimidazolines (e.g. 1-vinylimidazole), of the vinylpyrrolidones (e.g. N-vinylpyrrolidone), and/or of the alicyclic vinyl compounds (for example 4-vinyl-1-cyclohexene, vinylcyclohexane, vinylcyclopentane, etc.).

The modified polymers have particular properties which are attributable to some extent to the properties of the main polymers used for the modification process, to some extent to the graft monomers used, to some extent to the modification process used, and/or to a combination.

It is very particularly preferable that the monomers used for the modification process involve one or more silanes, and in particular the silanes have been grafted onto the copolymer or terpolymer. Silane-modified poly-alpha-olefins are the preferred representatives of the class of the moisture-crosslinking hot-melt adhesives.

The silane to be grafted onto the materials preferably has olefinic double bonds, and also from one to three alkoxy groups directly bonded to the silicon atom. In particular, the one or more silanes have been selected from the group consisting of vinyltrimethoxysilane (VTMO), vinyltriethoxysilane, vinyltris(2-methoxyethoxy)silane, 3-methacryloxypropyltrimethoxysilane (MEMO; H₂C═C(CH₃)COO(CH₂)₃—Si(OCH₃)₃), 3-methacryloxypropyltriethoxysilane, vinyldimethylmethoxysilane and/or vinylmethyldibutoxysilane. It is very particularly preferable that the silane is vinyltrimethoxysilane.

Any of the methods of the prior art can be used to graft the one or more silanes onto the main polymer, for example in solution or preferably in the melt, and an adequate amount of a free-radical donor is used here. A suitable procedure can be found in DE-A 40 00 695, which is expressly incorporated by way of reference. By way of example, the following free-radical donors can be used: diacyl peroxides, e.g. dilauroyl peroxide or didecanoyl peroxide, alkyl peresters, e.g. tert-butyl 2-ethyl-peroxyhexanoate, perketals, e.g. 1,1-di(tert-butylperoxy)-3,3,5-trimethylcyclohexane or 1,1-di(tert-butylperoxy)cyclohexane, dialkyl peroxides, e.g. tert-butylcumyl peroxide, di(tert-butyl)peroxide or dicumyl peroxide, C-free-radical donors, e.g. 3,4-dimethyl-3,4-diphenylhexane or 2,3-dimethyl-2,3-diphenylbutane, and also azo compounds, e.g. azobisisobutyronitrile, 2,2′-azodi(2-acetoxypropane) etc.

In one particular embodiment, a solution process is involved, where aliphatic and/or aromatic hydrocarbons, and also cyclic ethers can be used as solvents. It is particularly preferable to use, as solvent, at least one aromatic hydrocarbon. Suitable aromatic hydrocarbons are in particular trichlorobenzene, dichlorobenzene, toluene and xylene, and it is particularly preferable to use xylene. Examples of particularly preferred aliphatic hydrocarbons are propane, n-butane, hexane, heptane, cyclohexane and octane. Particularly preferred cyclic ether is tetrahydrofuran (THF).

If ethers, in particular cyclic ethers, are used as solvents, the initiator used, and also the process parameters (e.g. temperature, pressure, residence times, etc.) must be selected with particular care in order to suppress or control the formation of explosive peroxides of the ethers used. In particular, consideration should be given to the additional use of specific inhibitors (e.g. IONOL).

In the case of a grafting process in solution, the concentration of the main polymer used is at least 10 ma %, preferably at least 15 ma %, particularly preferably at least 20 ma % and with particular preference at least 22.5 ma %. The reaction temperature for the grafting process in solution is from 30 to 200° C., preferably from 40 to 190° C., particularly preferably from 50 to 180° C. and with particular preference from 55 to 140° C. The solution grafting process takes place either batchwise or continuously. In the case of batchwise conduct of the reaction, the solid polymer (e.g. in the form of granules, powder, etc.) is first dissolved in the solvent used. As an alternative to this, a conditioned polymerization solution is used directly from the production process for the main polymer, and is brought to reaction temperature. The monomer(s) and the free-radical initiator(s) are then added. In one particularly preferred embodiment, solvent, main polymer(s) and monomer(s) are used as initial charge and brought to reaction temperature, while the free-radical initiator(s) is/are metered continuously into the mixture over a defined period. An advantage of this is that the steady-state free-radical concentration is low and the ratio of grafting reaction to chain cleavage is therefore particularly advantageous (i.e. more grafting reaction and less chain cleavage). In another particularly preferred embodiment, solvent and main polymer(s) are used as initial charge and brought to reaction temperature, while monomer(s) and free-radical initiator(s) are continuously metered into the mixture over a defined period—together or separately from one another. An advantage of this is that the steady-state free-radical concentration, and also the monomer concentration, are low at the reaction site, and this suppresses not only chain cleavage but also the formation of homopolymers. This is particularly important when monomers are used which have a strong tendency towards thermally initiated (homo)polymerization at reaction temperature. It is very particularly preferable that, following the various metering periods defined, a further amount of free-radical initiator(s) is metered into the mixture, in order to minimise the content of residual monomers in the reaction solution. The reactor used preferably comprises a stirred tank, but it is equally possible, and in particular at low reaction temperatures and/or at high polymer concentrations it is preferable, to use alternative reaction vessels, e.g. batch kneader reactors.

In the case of continuous conduct of the reaction, the solid polymer is first dissolved in at least one solvent in one or more feed vessels (e.g. stirred tanks), and is then metered continuously into the reaction container(s). In an alternative embodiment, equally particularly preferred, a conditioned polymer solution is used directly from a production process for the main polymer. In another embodiment, equally particularly preferred, the solid polymer (e.g. in the form of powder, granules, pellets, etc.) is metered together with at least one solvent continuously into a single- or multiscrew machine or a continuous kneader, dissolved with exposure to heat and/or shear, and then metered continuously into the reaction container(s). Reaction containers or reactors that can be used for the conduct of the continuous grafting reaction in solution are continuous stirred tanks, stirred-tank cascades, flow tubes, flow tubes with forced conveying (e.g. screw-based machines), reaction kneaders, and also any desired combinations of these. If flow tubes with forced conveying are used, extruders are preferably involved here, and it is possible to use either single- or twin-, or else multiscrew extruders. It is particularly preferable to use multiscrew extruders. For the continuous production of the modified polymers according to the invention in solution, particular preference is given to the use of a reactor combination made of flow tube, flow tube with forced conveying and continuous stirred tank, where residual monomers and volatile by-products/volatile degradation products are preferably also removed either in the flow tube with forced conveying or in the continuous stirred tank.

Alternatively, a melt process is preferably involved, where at least one free-radical initiator is metered directly into the melt. In particular in this process variant the temperature of the polymer composition at the juncture of metering at least one free-radical initiator into the mixture is above the SADT (self accelerating decomposition temperature=temperature above which onset of self-accelerating decomposition is possible) of at least one of the free-radical initiators metered into the mixture. The reaction temperature for the grafting process in the melt is from 160 to 250° C., preferably from 165 to 240° C., particularly preferably from 168 to 235° C. and with particular preference from 170 to 230° C.

The grafting process in the melt takes place either batchwise or continuously. In the case of batchwise conduct of the reaction, the solid polymer (e.g. in the form of granules, powder, pellets, etc.) is first melted and optionally homogenized. Alternatively, a conditioned polymer melt from a polymerization process is used directly and brought to reaction temperature. Monomer(s) and free-radical initiator(s) are then added.

In one particular embodiment, monomer(s) and polymer melt are mixed homogeneously and brought to reaction temperature, while the free-radical initiator(s) is/are metered into the mixture continuously over a defined period. An advantage of this is that the steady-state free-radical concentration is low, and the ratio of grafting reaction to chain cleavage is therefore particularly advantageous (i.e. more grafting reaction and less chain cleavage).

In another particularly preferred embodiment, the polymer melt is used as initial charge and homogenized, while monomer(s) and free-radical initiator are metered into the mixture continuously, together or separately, over a defined period. An advantage of this is that not only the steady-state free-radical concentration but also the monomer concentration at the reaction site remains low, and this suppresses not only chain cleavage but also the formation of homopolymer. The latter is particularly important when using monomers which have a tendency towards thermal (homo)polymerization at the prevailing reaction temperature. The reactor used preferably comprises a stirred tank with stirrer assembly extending close to the walls, or a reaction kneader.

In the case of continuous conduct of the reaction, the solid polymer is first melted in one or more feed containers (e.g. stirred tanks), and is then metered continuously into the reaction container(s). In an alternative embodiment, equally particularly preferred, a conditioned polymer melt is used directly from a polymerization process. In another embodiment, equally particularly preferred, the solid polymer (e.g. in the form of powder, granules, pellets, etc.) is metered continuously into a (single- or multiscrew) machine or a continuous kneader, melted with exposure to heat and/or shear, and then metered continuously into the reaction container(s). Reaction containers or reactors that can be used for the conduct of the continuous grafting reaction in the melt are continuous stirred tanks, stirred-tank cascades, flow tubes, flow tubes with forced conveying (e.g. screw-based machines), reaction kneaders, and also any desired combinations of these. If flow tubes with forced conveying are used, it is preferable that extruders are involved, and not only single- and twin- but also multiscrew extruders are used. It is particularly preferable to use multiscrew extruders. For the continuous production of the modified polymers according to the invention in the melt, it is particularly preferable to use a reactor combination made of flow tube, flow tube with forced conveying and continuous stirred tank, where residual monomers and volatile by-products/volatile degradation products are preferably also removed either in the flow tube with forced conveying or in the continuous stirred tank. The silicon content of the polyolefins used according to the invention, determined by XRF spectroscopy (X-ray fluorescence spectroscopy) (after complete removal of unreacted residual monomer) is at least 0.3 ma %, preferably at least 0.35 ma %, particularly preferably at least 0.4 ma % and with particular preference from 0.45 to 2 ma %, and further regions particularly preferred here are from 0.5 to 0.75 ma %, from 0.7 to 0.95 ma %, from 0.8 to 1.25 ma % and from 1.1 to 2 ma %.

Other suitable materials are reactive hot-melt adhesives based on mixtures of polyols, for example polyesters, and isocyanates. Corresponding hot-melt adhesives are known to the person skilled in the art by way of example from DE 2401320, EP 0107097, EP 0125009, EP 0340906, DE 3827224 or WO 99/28363.

The present invention equally provides processes for the packaging of products requiring packaging with packaging films according to the present invention. In the processes according to the invention, it is preferable that a prescribed portion of the product requiring packaging is charged to a bag or tube of a packaging film according to the invention, the charging procedure is interrupted, and the bag or tube of the packaging film is closed by squeezing at one or both ends and is welded. It is surprising to the person skilled in the art that, in the process according to the invention, despite the silicone coating, an impermeable weld can be successfully achieved. The person skilled in the art would expect that the release-agent effect usually associated with silicones would render welding difficult or impossible. Surprisingly, it has been found that this effect does not occur, but instead the packaging films according to the present invention, coated with silicones, can also be welded easily, without any occurrence of permeability problems.

In another preferred embodiment of the process according to the invention, a prescribed portion of the product requiring packaging is charged to a bag or tube of a packaging film according to the invention, the charging procedure is not interrupted here, and the bag or tube of the packaging film is closed by squeezing at one or both ends, the product requiring packaging is displaced and the bag or tube is welded.

The products requiring packaging in the process according to the invention, in particular hot-melt adhesives, very particularly moisture-crosslinking hot-melt adhesives, are introduced into a bag or tube of the packaging film according to the invention.

The tube of the packaging film according to the invention is obtained by unwinding the packaging film from a roll, mutually superposing the two longitudinal edges of the packaging film and then joining the two longitudinal edges, preferably by ultrasound welding. In the ultrasound welding process, it is generally only the surfaces to be bonded that are heated. The full thickness of the film is not heated.

Joining methods that can be used in conventional processes are thermal welding and thermal welding with simultaneously applied pressure or adhesive bonding. In the thermal welding process, a weld is formed in the overlapping region of the longitudinal edges by treating the region of the weld with hot air. In the thermal welding process under pressure, the material is also compressed, for example by way of jaws or nippers that exert pressure onto one another. The jointing methods mentioned provide only poor welding of composite films.

It is preferable that when hot-melt adhesives are used these are introduced in liquid form, i.e. at temperatures above the melting point of the hot-melt adhesives. Usual draw-off temperatures are therefore in the range above 130° C., in particular from 150 to 160° C.

Material can be charged continuously or batchwise to the tubes obtained by unwinding the packaging film from a roll, mutually superposing the two longitudinal edges of the packaging film and then joining the two longitudinal edges.

For this, the tube is formed and a transverse weld is produced, whereupon a bag open towards one side is produced. The liquid hot-melt adhesive is charged through a filler tube in the manner known to the person skilled in the art.

When the desired fill level has been reached, the charging procedure is interrupted and the bag or tube of the packaging film is closed by squeezing at one or both ends and is welded.

The squeezing process can take place in any of the ways known to the person skilled in the art, for example by means of two parallel and opposite rollers, the distance between which can be altered, and between which the tube runs. In another embodiment, the squeezing process uses two jaws parallel to one another and exerting pressure against one another. The said jaws can have been provided to some extent with elevations and depressions. It is preferable that during the squeezing process the elevations on one of the sides of the jaw are forced into depressions matched thereto on the opposite side of the jaw.

The production of other types of packaging is also possible, alongside the production of tubes. It is therefore possible by way of example to produce (flat) bags by using an additional weld to join the resultant tube material transversely with respect to the longitudinal weld to give a bag open towards one transverse side. Material can be charged to the said bag, and it can then be closed by a second transverse weld.

Bags can be produced by any of the methods known to the person skilled in the art. By way of example, round-based sacks are obtained by using welding to attach a circular piece of composite film to a cylindrical tube section. These can be closed by a second transverse weld.

Embodiments in which the resultant bags or sacks have been provided with valves are equally possible. In other embodiments, the sacks comprise gases, in particular inert gases such as nitrogen or argon. In another embodiment, subatmospheric pressure prevails in the packaging.

The welding process in particular takes place through ultrasound welding. In the ultrasound welding process, it is generally only the surfaces to be bonded that are heated. The full thickness of the film is generally not heated. In the ultrasound welding process, ultrasound waves with a frequency of more than 16 kHz are generated in an ultrasound generator, and these are converted to mechanical vibrations in an ultrasound converter and are conducted mechanically to a sonotrode. This vibrates in resonance and moves periodically against the workpieces to be welded, the location of which is on a counter-component, the anvil. Within the workpieces, the mechanical energy introduced by the sonotrode is converted into internal friction and into heat. The workpieces to be joined here become heated, and the materials are welded. For the purposes of the present invention, it is possible in particular to use ultrasound welding processes with fixed or rotating sonotrode. The anvil can likewise be of rotating or fixed design. In the fixed design, sonotrode and/or anvil can have the shape of a bar.

Silicones are generally used as release agents and lubricants. The person skilled in the art expects that the silicones on the packaging films described will likewise have a release effect and prevent welding. Surprisingly, it has been found that despite the presence of the silicones on the surfaces welds are produced. Surprisingly, the said welds are even suitable for withstanding high pressure.

The ultrasound welding process involves a plurality of parameters, in particular the ultrasound power rating to be selected.

The ultrasound power rating of the sonotrode in the process according to the invention is by way of example, when rotating sonotrodes are used, preferably from 1 W to 1000 W, particularly preferably from 5 W to 100 W and very particularly preferably from 8 W to 50 W. The frequency of the ultrasound in the process according to the invention is preferably greater than 16 kHz and smaller than 100 kHz, particularly preferably from 16 kHz to 40 kHz.

The amplitude in the process according to the invention, i.e. the maximum spatial deflection of the sonotrode, is from 2 μm to 100 μm, preferably from 10 to 30 μm.

Sonotrode and anvil in the welding procedure can be forced against one another by their own weight, by additional weights, hydraulically or pneumatically or by the drive from a motor. In one preferred embodiment according to the invention, sonotrode and anvil are forced against one another by a pressure. The said pressure corresponds to a weight of from 10 g to 50 kg, preferably from 100 g to 10 kg and very particularly preferably from 200 g to 2 kg.

In the continuous process, the advance rate of the welding process is from 0.1 m/min to 30 m/min, preferably from 0.5 m/min to 10 m/min and very particularly preferably from 1 m/min to 5 m/min.

In principle, there are no restrictions on the geometry of sonotrode and/or anvil wheel. “Wheel” hereinafter means the sonotrode wheel and/or the anvil wheel.

In one embodiment, the wheel can be a flat wheel or a flat wheel with incorporated structure or a curved or angular wheel. In the case of a flat wheel, this exerts pressure against the sonotrode or, respectively, the anvil over an area. An area weld is produced.

In the case of a flat wheel with structure, there are elevations or depressions on the peripheral surfaces. These can be linear grooves or can take the form of elevated areas. Linear grooves can have been introduced parallel to the diameter of the wheel or parallel to the wheel axis, or at any angle, and can mutually intersect or can have some discontinuities.

If the embodiment of the sonotrode and/or of the anvil is a bar, this can be a flat bar or a flat bar with incorporated structure or a curved or angled bar. In the case of a flat anvil, this exerts pressure against the sonotrode or, respectively, the anvil over an area. An area weld is produced.

In the case of a flat anvil or flat sonotrode with structure, there are elevations or depressions on the surfaces of these. These can be linear grooves or can take the form of elevated areas. Linear grooves can have been introduced parallel to the longitudinal axis of the bar or perpendicular to the longitudinal axis of the bar, or at any angle, and can mutually intersect or can have some discontinuities.

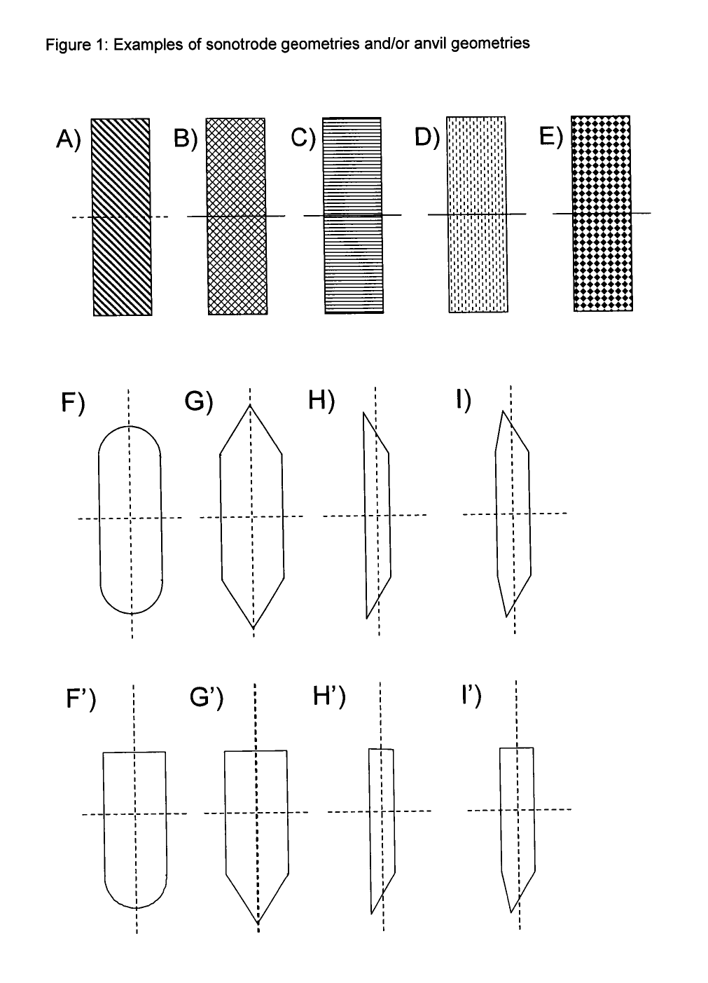

FIG. 1 shows examples of the structuring of flat sonotrode wheels and/or flat anvil wheels and, respectively, fixed sonotrode bars and/or anvil bars with various linear grooves and elevated areas, and also examples of various geometries of the sonotrode wheels and/or anvil wheels, in side view:

### Linear Grooves:

A) at any desired angles to the wheel axis,
B) mutually intersecting,
C) parallel to the wheel axis,
D) with some discontinuities.
E) Elevated areas,
F) curved wheel,
G) angular wheel with symmetry axis parallel to axis and perpendicular to axis,
H) angular wheel with symmetry axis parallel to axis,
I) angular wheel with two different angles in relation to the direction perpendicular to the axis.

For bar-shaped sonotrodes or anvils, there is a corresponding cross-sectional geometry as shown in F′) to I′).

For fixed sonotrodes with fixed, disc-shaped anvils there is a corresponding cross-sectional geometry as shown in F) to I).

In one preferred embodiment, the anvil wheel corresponds to tooling in FIG. 1, Examples A) to D), suitable for area-welding processes. The preferred width of the wheel is from 1 mm to 10 mm, particularly preferably 1 mm to 5 mm. The wheel preferably has a pattern made of linear grooves. In contrast, the person skilled in the art would have expected area-welding processes to give particularly durable welds, or would have expected wider rollers to give more durable welds.

The production of a durable and long-lasting weld is not the only relevant factor in a continuous production process. Another important factor for packaging is that the edges of the packaging are dimensionally accurate and flush. However, tolerances in the guiding of the web which can in particular occur during the steps of unwinding of the packaging film from a roll and the mutual superposition of the two longitudinal edges of the packaging film can cause deviations in the overlap of the two longitudinal edges of the packaging film. Furthermore, the region of the film between weld and the longitudinal edge of the film is not necessary for the stability of the weld, and for reasons of appearance it is desirable to avoid this. It is therefore advantageous to remove this excess material. The person skilled in the art is aware of what are known as cutting wheels, which can separate workpieces, in particular by ultrasound cutting. Excess film can thus easily be removed by trimming.

Surprisingly, it has been found that cutting wheels corresponding to angular anvil wheels of FIG. 1, Examples G) to I) are also suitable for the welding of the composite films coated with silicones.

This is surprisingly firstly because the person skilled in the art is aware that silicone coatings have a release effect and secondly because cutting wheels are unlike the flat welding anvil wheels in having a very small contact area, designed specifically for the trimming process and not for the joining of materials.

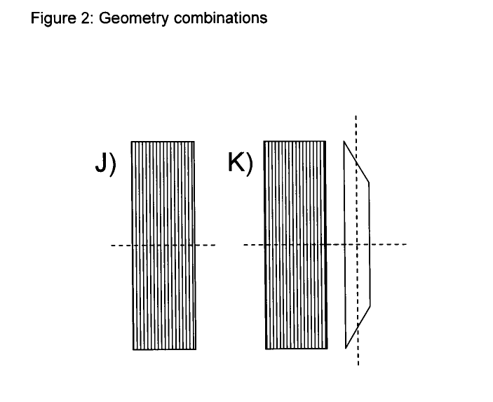

Combinations of a plurality of sonotrode wheels and/or anvil wheels are moreover also possible, and these can also be different. By way of example, therefore, it is possible to combine an anvil wheel with linear grooves J) with an angular wheel with symmetry axis parallel to the axis to give an arrangement K) (see FIG. 2).

Surprisingly, it has been found that in a very particularly preferred embodiment it is possible to omit the use of an anvil wheel selected from A) to E) and that durable welds are obtained merely by using a wheel selected from Example G), H) or I).

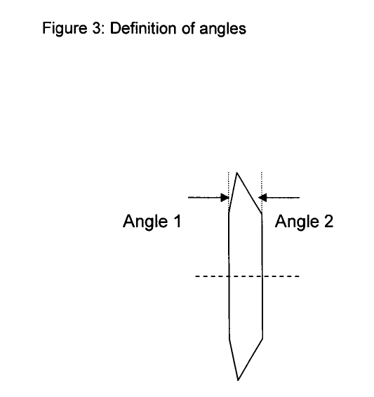

For the transverse welding process, it is particularly preferable to use a wheel according to Example G), where with particular preference the angles 1 and 2 are equal (see FIG. 3 for the definition of the angles).

The diameter of sonotrode wheel and anvil wheel is in particular from 5 mm to 100 mm.

In another preferred embodiment of the process according to the invention, a bar-shaped sonotrode is used. The width of the sonotrode is preferably from 50 mm to 1000 mm, particularly preferably from 100 mm to 500 mm. The height of the sonotrode is from 0.01 mm to 50 mm, very particularly preferably from 10 mm to 200 mm.

For area-welding processes, the structure of the bar sonotrode and of the bar-shaped anvil corresponds to FIG. 1A) to E).

In one particular embodiment, the bar sonotrode as in FIG. 1 F′) to I′) produces a linear weld. The width of the said sonotrode is preferably from 50 mm to 1000 mm, particularly preferably from 100 mm to 500 mm. In the case of a cross section as in FIG. 1 F′), the curvature radii are from 0.01 mm to 1 mm. The angles of the cross sections 1 G′) to I′) are from 10° to 80°, preferably from 20° to 70°.

It is particularly advantageous that, with linear sonotrodes of this type, welds can be produced between two films of the structure according to the invention and at the same time the films of the structure according to the invention can be trimmed in front of and behind the weld position.

In contrast, the person skilled in the art would have expected linear welding processes of this type not to give durable welds, or would not have expected to obtain durable welds with simultaneous trimming of excess film.

The ultrasound power rating of the bar-shaped sonotrodes in the process according to the invention is preferably from 1 W to 5000 W, particularly preferably from 100 W to 3000 W and very particularly preferably from 500 W to 2500 W. The frequency of the ultrasound in the process according to the invention is preferably greater than 16 kHz and smaller than 100 kHz, particularly preferably from 16 kHz to 40 kHz.

The amplitude in the process according to the invention, i.e. the maximum spatial deflection of the sonotrode, is from 2 μm to 100 μm, preferably from 10 to 30 μm.

It is assumed that a person skilled in the art can utilise the above description to the fullest extent even without further information. The preferred embodiments and examples are therefore to be interpreted merely as descriptive disclosure, and certainly not in any way as limiting disclosure.

Examples are used below for further explanation of the present invention. Alternative embodiments of the present invention are obtainable analogously.

### EXAMPLES

### Example 1

A silicone-coated PP (70 μm)/aluminium (9 μm)/PP (70 μm) composite film was welded. The silicone layer was produced from a mixture of 9% by weight of TEGO RC351, 89% by weight of TEGO RC702 and 2% by weight of TEGO A18 photo-initiator. The thickness of the coating was about 1 g/m². The composite film was folded back onto itself in such a way that the silicone side overlapped the silicone side. An ultrasound weld was applied in this region.

An angular anvil wheel was used, with a diameter of 65 mm, angle 1=15° and angle 2=75° (see definition according to FIG. 3).

Welding parameters: power=25 W, pressure corresponding to weight of 1.2 kg, frequency=20 kHz, amplitude from 10 μm to 25 μm, advance rate being 2 m/min. An important factor for the process according to the invention is a durable weld which does not part even when subjected to pressure.

In a pressure test, the film was therefore clamped into a holder ring so as to form a leakproof seal, and subject it to a pressure of 0.8 bar, thus subjecting the weld to shear from the inside. Both the weld and the film withstand the pressure. When the pressure is further increased as far as 1 bar, the weld still remains intact, but the composite film begins to stretch.

A tensile testing machine was moreover used to measure tensile forces both on the unwelded composite film and on two welded pieces of the said composite film by a method based on that of DIN EN ISO 527-3. The resultant tensile forces in both cases are 60 N/inch.

### Example 2

A silicone-coated PP (70 μm)/aluminium (9 μm)/PP (70 μm) composite film was welded. The silicone layer was produced from a mixture of 9% by weight of TEGO RC351, 89% by weight of TEGO RC702 and 2% by weight of TEGO A18 photo-initiator. The composite film was folded back onto itself in such a way that the silicone side overlapped the silicone side. An ultrasound weld was applied in this region.

A bar-shaped sonotrode of width 250 mm, with waffle structure, was used in an HS dialog 4000 ultrasound welding machine with anvil from Hermann Ultraschall, operated at 20 kHz. The deflection of the sonotrode in the direction of vibration was 21 μm, and the welding time was 250 ms with power of 1500 W with an applied pressure of 6 bar, the energy introduced into the weld being 320 J.

### Impermeability Test:

Coloured water was charged to the prefabricated bag. The water did not penetrate into the welds or through the welds, and the weld obtained was therefore impermeable to escape of liquids. A gas bubble intentionally included concomitantly could not be expelled manually. The bags do not separate.

### Charging Test:

In a second experiment, Vestoplast® 206 (silane-modified polyolefin from Evonik Industries AG) at 160° C. was charged to the bag obtained, and the bag was closed (ultrasound welding as revealed above). The welds remained impermeable and did not separate. Residue-free removal of the bag from the polyolefin was possible after cooling of the melt. After the bags and contents had been stored for 1 year, there was no discernible contamination by air or moisture (no crosslinking of the polymer). A gas bubble intentionally included concomitantly could not be expelled manually, and the welds also remained stable during storage.

### Example 3

The film from Example 2 was used. The composite film was folded back on itself in such a way that the silicone side overlapped the silicone side. An ultrasound weld was applied in this region.

A bar-shaped cutting anvil from FIG. 1G′ was used, with an angle of 120°, with an applied pressure of 5 bar. The welding time was 230 ms at 2000 W, the energy introduced into the weld being 360 J. At the same time, the excess film beyond the weld is removed from the weld.

### Impermeability Test:

Coloured water was charged to the prefabricated bag. The water did not penetrate into the welds or through the welds, and the weld obtained was therefore impermeable to escape of liquids. A gas bubble intentionally included concomitantly could not be expelled manually. The bags do not separate.

### Charging Test:

In a second experiment, Vestoplast® 206 (silane-modified polyolefin from Evonik Industries AG) at 160° C. was charged to the bag obtained, and the bag was closed (ultrasound welding as revealed above). The welds remained impermeable and did not separate. Residue-free removal of the bag from the polyolefin was possible after cooling of the melt. After the bags and contents had been stored for 1 year, there was no discernible contamination by air or moisture (no crosslinking of the polymer). A gas bubble intentionally included concomitantly could not be expelled manually, and the welds also remained stable during storage. The bags do not separate.

### Example 4

The film from Example 2 was used. The thickness of the coating was about 0.5 g/m². The composite film was folded back on itself in such a way that the silicone side overlapped the silicone side. An ultrasound weld was applied in this region.

A disc-shaped cutting anvil with diameter 2.5 mm from FIG. 1G was used, with an angle of 120°, with an applied pressure of 5 bar.

The sonotrode was operated continuously at 600 W with a 35 kHz generator. At the same time, the film beyond the weld is removed from the weld.

### Impermeability Test:

Coloured water was charged to the prefabricated bag. The water did not penetrate into the welds or through the welds, and the weld obtained was therefore impermeable to escape of liquids. A gas bubble intentionally included concomitantly could not be expelled manually.

### Charging Test:

In a second experiment, Vestoplast® 206 (silane-modified polyolefin from Evonik Industries AG) at 160° C. was charged to the bag obtained, and the bag was closed (ultrasound welding as revealed above). The welds remained impermeable and did not separate. Residue-free removal of the bag from the polyolefin was possible after cooling of the melt. After the bags and contents had been stored for 1 year, there was no discernible contamination by air or moisture (no crosslinking of the polymer). A gas bubble intentionally included concomitantly could not be expelled manually, and the welds also remained stable during storage.

### Example 5

The film from Example 2 was used. The thickness of the coating was about 0.5 g/m². The composite film was folded back on itself in such a way that the silicone side overlapped the silicone side. An ultrasound weld was applied in this region.

A flat bar-shaped sonotrode was used, with height 5 mm and width 250 mm, and waffle structure, from FIG. 1 B).

The sonotrode was operated for 580 ms at 2100 W with a 20 kHz generator, the energy introduced into the weld being 700 J.

### Impermeability Test:

Coloured water was charged to the prefabricated bag. The water did not penetrate into the welds or through the welds, and the weld obtained was therefore impermeable to escape of liquids. A gas bubble intentionally included concomitantly could not be expelled manually. The bags do not separate.

### Charging Test:

In a second experiment, Vestoplast® 206 (silane-modified polyolefin from Evonik Industries AG) at 160° C. was charged to the bag obtained, and the bag was closed (ultrasound welding as revealed above). The welds remained impermeable and did not separate. Residue-free removal of the bag from the polyolefin was possible after cooling of the melt. After the bags and contents had been stored for 1 year, there was no discernible contamination by air or moisture (no crosslinking of the polymer). A gas bubble intentionally included concomitantly could not be expelled manually, and the welds also remained stable during storage. The bags do not separate.

### Example 6

A composite film composed of a silicone-coated PP film of thickness 140 μm was welded. The silicone layer was produced from a mixture of 9% by weight of TEGO RC351, 89% by weight of TEGO RC702 and 2% by weight of TEGO A18 photo-initiator. The film was folded back onto itself in such a way that the silicone side overlapped the silicone side. An ultrasound weld was applied in this region.

A bar-shaped sonotrode of width 250 mm, with waffle structure, was used in an HS dialog 4000 ultrasound welding machine with anvil from Hermann Ultraschall, operated at 20 kHz. The deflection of the sonotrode in the direction of vibration was 21 μm, and the welding time was 250 ms with power of 1400 W with an applied pressure of 6 bar, the energy introduced into the weld being 310 J.

### Impermeability Test:

Coloured water was charged to the prefabricated bag. The water did not penetrate into the welds or through the welds, and the weld obtained was therefore impermeable to escape of liquids. A gas bubble intentionally included concomitantly could not be expelled manually. The bags do not separate.

### Charging Test:

In a second experiment, Vestoplast® 206 (silane-modified polyolefin from Evonik Industries AG) at 160° C. was charged to the bag obtained, and the bag was closed (ultrasound welding as revealed above). The welds remained impermeable and did not separate. Residue-free removal of the bag from the polyolefin was possible after cooling of the melt.

### Example 7

A composite film composed of a silicone-coated PE film of thickness 100 μm was welded. The silicone layer was produced from a mixture of 9% by weight of TEGO RC351, 89% by weight of TEGO RC702 and 2% by weight of TEGO A18 photo-initiator. The film was folded back onto itself in such a way that the silicone side overlapped the silicone side. An ultrasound weld was applied in this region.

A bar-shaped sonotrode of width 250 mm, with waffle structure, was used in an HS dialog 4000 ultrasound welding machine with anvil from Hermann Ultraschall, operated at 20 kHz. The deflection of the sonotrode in the direction of vibration was 21 μm, and the welding time was 250 ms with power of 850 W with an applied pressure of 6 bar, the energy introduced into the weld being 200 J.

### Impermeability Test:

Coloured water was charged to the prefabricated bag. The water did not penetrate into the welds or through the welds, and the weld obtained was therefore impermeable to escape of liquids. A gas bubble intentionally included concomitantly could not be expelled manually. The bags do not separate.

### Charging Test:

In a second experiment, Vestoplast® 206 (silane-modified polyolefin from Evonik Industries AG) at 110° C. was charged to the bag obtained, and the bag was closed (ultrasound welding as revealed above). The welds remained impermeable and did not separate. Residue-free removal of the bag from the polyolefin was possible after cooling of the melt.

As used herein the terms composed of, contains, containing, and terms similar thereto, when referring to the ingredients, parts, reactants, etc., of a composition, component, etc., to method steps, etc., mean, in their broadest sense, “includes at least” (i.e., comprises) but also include within their definition all those gradually restricted meanings until and including the point where only the enumerated materials or steps are included (e.g., consisting essentially of and consisting of).

The above written description of the invention provides a manner and process of making and using it such that any person skilled in this art is enabled to make and use the same, this enablement being provided in particular for the subject matter of the appended claims, which make up a part of the original description. As used herein, the phrases “selected from the group consisting of,” “chosen from,” and the like include mixtures of the specified materials. The term “mentioned” notes exemplary embodiments, and is not limiting to certain species. As used herein the words “a” and “an” and the like carry the meaning of “one or more.” When a polymer is referred to in shorthand notation as comprising a monomer (or like phrases), the monomer is present in the polymer in polymerized form.

All references, patents, applications, tests, standards, documents, publications, brochures, texts, articles, etc. mentioned herein are incorporated herein by reference. Where a numerical limit or range is stated, the endpoints are included. Also, all values and subranges within a numerical limit or range are specifically included as if explicitly written out.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein. In this regard, certain embodiments within the invention may not show every benefit of the invention, considered broadly.

1. A multilayer packaging film, comprising a layer comprising a thermoplastic, wherein a coating comprising a silicone has been applied on a side of the packaging film that faces towards a product requiring packaging.

2. The packaging film according to claim 1, comprising two layers of at least one polymer and, located between the layers, a metal sublayer, wherein at least one of the two layers of the at least one polymer comprises the thermoplastic.

3. The packaging film according to claim 2, wherein the metal sublayer comprises a lightweight metal.

4. The packaging film according to claim 1, wherein the thermoplastic is at least one selected from the group consisting of a polyolefin, a polyamide, a polybutadiene, a polyester, a polycarbonate, a polyvinyl acetate, a thermoplastic polyacrylamide, a polyacrylonitrile, a polymethylpentene, a polyphenylene sulphide, a polyurethane, a styrene-acrylonitrile, a acrylonitrile-butadiene-styrene, a styrene-butadiene rubber, and a polyethylene terephthalate.

5. The packaging film according to claim 1, wherein the silicone comprises a polysiloxane comprising (meth)acrylate groups.

6. A process for packaging products, the process comprising applying the multilayer packaging film according to claim 1 to a package capable of containing a product.

7. The process according to claim 6, wherein the product is a hot-melt adhesive.

8. The process according to claim 7, wherein the product is a reactive hot-melt adhesive.

9. The process according to claim 6, further comprising charging a prescribed portion of the product to a bag or tube of the packaging film, with interruption of the charging procedure, and the bag or tube of the packaging film is closed by squeezing at one or both ends and is welded.

10. The process according to claim 6, further comprising charging a prescribed portion of the product to a bag or tube of a packaging film, without interruption of the charging procedure, and the bag or tube of the packaging film is closed by squeezing at one or both ends, such that the product is displaced and the bag or tube is welded.

11. The process according to claim 9, wherein the packaging film is welded with ultrasound.

12. The packaging film according to claim 2, wherein the metal sublayer comprises aluminum.

13. The process according to claim 7, wherein the product is a reactive, moisture-crosslinking hot-melt adhesive.

14. The process according to claim 10, wherein the packaging film is welded with ultrasound.
